(19) United States
(12) Patent Application Publication
(10) Pub. No.: US 2025/0225114 A1
(43) Pub. Date: Jul. 10, 2025

(54) AUTOMATED FACT-CHECKING INTEGRATED IN A WEB BROWSER

(71) Applicant: Gen Digital Inc., Tempe, AZ (US)

(72) Inventors: Vibhor Sehgal, San Francisco, CA (US); Rafael Muñoz Gómez, Prague (CZ); Štepán Dvorák, Podebrady (CZ); Viliam Lisý, Prague (CZ)

(73) Assignee: Gen Digital Inc., Tempe, AZ (US)

(21) Appl. No.: 18/406,838

(22) Filed: Jan. 8, 2024

(51) Int. Cl. G06F 16/215; G06F 16/958

(52) U.S. Cl. CPC G06F 16/215; G06F 16/958

(57) ABSTRACT

A web browser extension is operable to identify content in a web page that is potentially misinformation, and to compare the at least one content element against a database of verified information. The comparison process determines whether a verified information element in the database corresponds to the at least one content element, and if a verified information element in the database is found to correspond to the at least one content element, the verified information element in the database is displayed in association with the at least one content element via the web browser.

### FIELD

The field relates generally to use of web browsers to retrieve information over a network, and more specifically to automated fact-checking in a web browser.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to use computers in unintended or undesirable ways. Hackers may communicate with other users' computers in a manner that poses a danger to the other users, such as attempting to log in to a corporate computer to steal, delete, or change information. Computer viruses or Trojan horse programs may be distributed to other computers or unknowingly downloaded such as through email, download links, or smartphone apps. More recently, those with political interests may use the Internet to distribute misinformation or “fake news” in an attempt to sway public discourse or opinion regarding sensitive topics such as elections, wars, government programs, and the like.

While use of misinformation or fake news to attract public interest or sway public opinion is a centuries-old phenomenon, the prevalence of fake news has spread rapidly with the rise of social media, parody new sites, and the like. Many studies have shown that fake news articles can compete with or even receive more engagement than mainstream news articles from major outlets on social media platforms such as Facebook, and are up to 70% more likely to be retweeted on platforms such as Twitter (or X) than verifiably true news stories. The prevalence of such misinformation has contributed to increasing polarization among society, distrust in government and mainstream news, and “relativization” of truth.

Further, misleading content can have serious consequences, such as when 60% of people surveyed in 2020 reported that they had seen misinformation related to COVID-19. Misleading information about public health, public policy, science, and the like can have serious consequences when people are encouraged to not believe in or to rally against established science regarding subjects like a pandemic, climate change, or the like, causing people to act against their own best interests out of mistaken beliefs. Fake news can also reduce the impact of real news, such as when fake news regarding a political candidate overshadows actual news regarding their actions or positions. Misleading information about individuals, businesses, or organizations can damage their reputation and cause emotional harm, as well as distract from the message or work being done by the affected person or group.

Because people are often influenced by confirmation bias and motivated reasoning when reading fake news or other such misinformation, fake news may be spread more easily than actual news by those who do not actively confront false narratives, or take care when sharing information to fact-check the information first. With the recent proliferation of generative algorithms such as transformers and recurrent neural networks, these models can be trained to generate fake news articles, reviews, or social media posts that are further designed to mislead or deceive people. For example, a generative AI tool may be programmed to engage in discussion on common social media platforms using different names or aliases to spread misinformation and make it appear as though public support or opinion on a subject is different from reality.

For reasons such as these, a need exists for identifying and managing misinformation or fake news on the Internet.

### SUMMARY

One example embodiment comprises identify content in a web page that is potentially misinformation via a web browser plugin, and comparing the at least one content element against a database of verified information. The comparison process determines whether a verified information element in the database corresponds to the at least one content element, and if a verified information element in the database is found to correspond to the at least one content element, the verified information element in the database is displayed in association with the at least one content element via the web browser.

In a further embodiment, the web browser is operable to send a request comprising the at least one content element to a remote server for determination regarding whether a verified information element in the database corresponds to the at least one content element, and the server is operable to send a reply indicating whether a verified information element in the database corresponds to the at least one content element along with information regarding verified information relating to the content element such as a verified fact, a reference link, or the like.

The details of one or more examples are set forth in the accompanying drawings and the description below. Other features and advantages will be apparent from the description and drawings, and from the claims.

### BRIEF DESCRIPTION OF THE FIGURES

FIG. 1 is a block diagram of a computing environment including a client and server operable to facilitate fact-checking via a browser extension, consistent with an example embodiment.

FIG. 2 is a drawing of a web browser screen, consistent with an example embodiment.

FIG. 3 is a flow diagram of a networked fact-checking system, consistent with an example embodiment, consistent with an example embodiment.

FIG. 4 is a flow diagram of a method of fact-checking web content in a web browser, consistent with an example embodiment, consistent with an example embodiment.

FIG. 5 is a computerized system employing a fact-checking browser extension, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made. Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they convey has grown exponentially. Computers are now used to perform many tasks that were previously performed manually, such as online shopping instead of driving to a store or mall to purchase goods or services, using social media instead of telephone or other means to keep in touch with friends and relatives, and online news sites that continue to replace newspapers and news broadcasts as a source of timely new information. But, misinformation, or “fake news,” has grown exponentially along with the rise of the Internet, and poses significant societal problems.

The ease with which misinformation or “fake news” may be spread on the Internet has resulted in an increase in prevalence of such misinformation and in user engagement with misinformation. Mistruths about election candidates, pandemics such as COVID-19, and information regarding wars or political conflicts have affected public discourse and increased polarization in society. Although some users attempt to fact-check such misinformation before spreading it, a greater number of people simply forward misinformation without any investigation due to factors such as confirmation bias, motivated reasoning, and malicious intent. The impact of misinformation on an individual or on society can be severe, such as when misinformation regarding a pandemic causes people to act contrary to their best interests and put their health at risk, or when a malicious foreign actor uses misinformation to affect the outcome of an election to destabilize a foreign country or cause its citizens to act in the interests of a foreign power.

Fake news has become easier to spread and more difficult to mange with the rise of social media sites such as Facebook and Twitter (now X), with misinformation often competing with or dominating the spread of factual news. A 2020 survey by the Pew Research Center indicating that 6 in 10 Americans reported that they had seen COVID-19 misinformation in 2020, and a 2018 study by the Massachusetts Institute of Technology similarly found that false news stories were 70% more likely to be re-tweeted on Twitter than factual news stories. Such misinformation can reduce the impact of real news, and make it appear as though scientific fact, occurrence of events, or public sentiment are different from reality.

Platform algorithms on social media sites such as Facebook and Twitter (now X) are designed to promote user engagement, often prioritizing presentation of content that users are most likely to read irrespective of the actual nature of the content. This contributes to misinformation or fake news often spreading faster or more effectively than real news, leading to increased polarization in society, distrust of authorities or government, and people acting against their own self-interests.

Misleading information about public health, such as vaccine effectiveness or safety during a pandemic, can cause significant portions of society to forego potentially lifesaving medical care. Similarly, misinformation regarding political candidates, events, or issues can sway elections, causing people to vote against their best interests and increasing polarization among a society. False information about public health, public policy, science, and the like can also have serious societal consequences when people are encouraged to not believe in or to rally against established science regarding subjects like a pandemic, climate change, or the like, causing people to act against their own best interests out of mistaken beliefs.

Fake news or misinformation can often spread more easily than actual news due to factors such as confirmation bias, motivated reasoning, and malicious intent, and most people motivated by such factors are not driven to fact-check such information before believing or sharing it. Significant percentages of fake news or misinformation during the 2016 and 2020 presidential elections and 2020 COVID pandemic were generated by a relatively small number of users, often using automated tools to spread the misinformation. The recent proliferation of generative artificial intelligence methods may serve to amplify these issues, enabling bad actors to train such tools to generate fake social media posts, fake social media conversations, fake news articles, fake reviews, or other such content that is designed to mislead or deceive people. For example, a generative AI tool may be programmed to author a fake news article and engage in discussion on common social media platforms regarding the article using different names or aliases to spread misinformation, making it appear as though the news article is legitimate and widely believed, and that public support or opinion on a subject is different from reality.

Some examples presented herein therefore provide for automated fact-checking in a web browser, such as by using an extension or a modified browser to fact-check information. In one such example, a web browser fact-checking extension or a web browser customized to include fact-checking functionality is operable to identify at least one content element such as text or an image that potentially contain misinformation. The identified content element is compared against a database of verified information to determine whether a verified information element in the database corresponds to the identified content element. If a verified information element in the database is found to correspond to the identified content element, the verified information content or other content associated with the verified information content are provided for display via the web browser, such as to alert a web browser user of potential misinformation in the web content being viewed. The alert in a further example displays the verified information content or other content associated with the verified information content, such as via a pop-up, a text bubble, a graphic element, or other indication. In another example, the user may select content, such as a sentence, a paragraph, or an image, and request that the browser plugin or customized web browser fact-check the selected content.

In some examples, a remote server is operable to receive requests from web browser extensions or web browsers otherwise configured to incorporate fact-checking, such as by receiving text, images, or other content for comparison against a database of verified information. The verified information database is in various examples configured to accumulate verified information from trusted sources such as online news sites, online encyclopedias such as Wikipedia, sources specializing in debunking misinformation such as Snopes.com, and other such trusted sources. The remote server in some such examples executes an ingestion task to populate the verified information database with trusted information, and a server task operable to compare incoming requests with verified information from the database and to return matching verified information to the requesting web browser or extension.

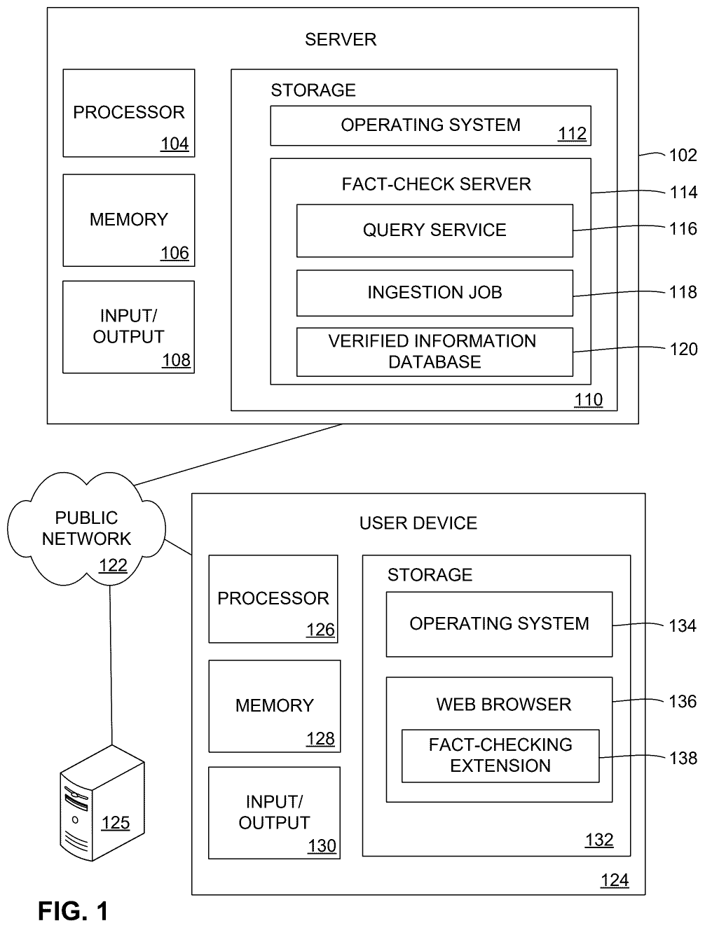

FIG. 1 is a block diagram of a computing environment including a user device 124 (e.g., a client) and server operable to facilitate fact-checking via a browser extension, consistent with an example embodiment. Here, the server 102 includes a processor 104 operable to execute computer program instructions and a memory 106 operable to store information such as program instructions and other data while server 102 is operating. The server exchanges electronic data, receives input from a user, and performs other such input/output operations with input/output 108. Storage 110 stores program instructions including an operating system 112 that provides an interface between software or programs available for execution and the hardware of the server, and manages other functions such as access to input/output devices. The storage 110 also stores program instructions and other data for a fact-checking server 114, including query service 116, ingestion job 118, and verified information database 120. In this example, the computerized device is also coupled via a public network 122 to one or more user devices 124, such as a user's smartphone or other remote client computerized device.

The user device 124 similarly includes a processor 126 operable to execute computer program instructions and a memory 128 operable to store information such as program instructions and other data while the user device is operating The user device exchanges electronic data, receives input from a user, and performs other such input/output operations with input/output 130. Storage 132 stores program instructions including an operating system 134 that provides an interface between software or programs available for execution and the hardware of the server, and manages other functions such as access to input/output devices. The storage 132 also stores program instructions and other data for a web browser 136 with a fact-checking extension 138. In this example, the user device is coupled to the server 102 via the public network 122.

In operation, a server 102 operates a fact-checking server 114 that performs a variety of functions to facilitate fact-checking queries received via query service 116 and verified information database 120. The ingestion job 118 is operable to search or scrape sources of trusted information to populate or augment the verified information database 120 with new facts, such as by checking trusted news sources, information repositories such as Wikipedia, sites specializing in debunking misinformation such as Snopes.com, and the like. In a more detailed example, a user using a user device 124 wishing to have web content they view via web browser 136 installs a fact-checking browser extension 138 that is operable to send displayed content to server 102 where query service 116 checks the displayed information against the verified information database 120 for corresponding verified information.

In a more detailed example, web browser 136 loads a web page such as from a remote server 125, comprising sentences or paragraphs of text which may contain misinformation or fake news. The fact-checking extension 138 identifies content that may contain misinformation, such as by looking for keywords, phrases, or the like that are known to be associated with misinformation, and selectively forwards this identified content to the server 102 for review. The server's query service 116 receives the request, and compares the identified content with information stored in the verified information database for corresponding verified information. If verified information is found, it is returned via the query service 116 to the web browser's fact-checking extension 138 for display to the user, such as by displaying a pop-up, a text bubble or other text augmentation, a graphic indication, or other such indication that the identified content may contain misinformation. In an alternate embodiment, the user may select one or more content elements, such as a sentence, a paragraph, a photograph, or the like to be fact-checked, and use a menu such as a right-clock context menu to request that the selected content be fact-checked using a process such as that described above via server 102.

The examples discussed in conjunction with FIG. 1 demonstrate how a browser extension or equivalent can be used to facilitate automated and/or on-demand fact-checking of content displayed on a web page, reducing the burden on users in fact-checking potential misinformation and helping stop the spread of misinformation or “fake news.” By employing automated fact-checking tools such as those described herein, the user need not leave their web page and search for information that corroborates or refutes false information and so is much more likely to be alerted to misinformation online. The fact-checking extension in some examples presents the user with the verified or trusted information that corroborates or refutes the web content in question, thereby allowing a user to educate themselves regarding the topic with the benefit of a more complete and accurate set of resources from which to draw information.

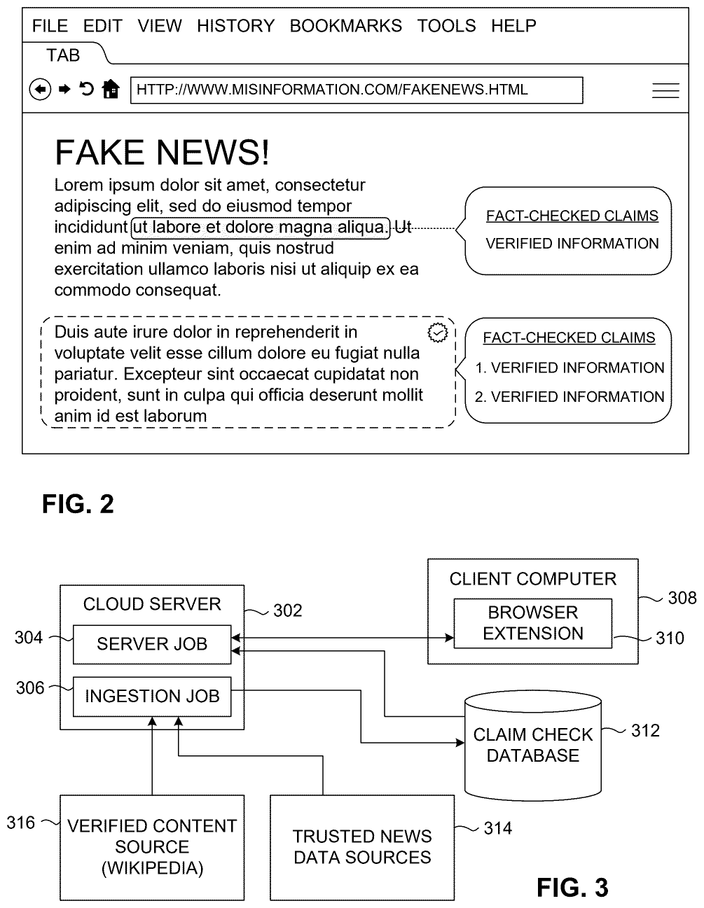

FIG. 2 is a drawing of a web browser screen, consistent with an example embodiment. Here, a fictitious website (www.misniformation.com/fakenews.html) comprising potential misinformation or fake news is displayed, including in the first paragraph a sentence which the user has elected to highlight and use a left-click context menu to fact-check via the installed fact-check extension. In an alternate example, the user initiates the fact-check plugin by a method such as left clicking and selecting the extension from a context menu, and the extension enables the user to select a sentence, phrase, paragraph, or other block of text for fact-checking. In a further example, the user may similarly select other displayed content, such as an image, a video, or a graphic for fact-checking. Upon selection of displayed content for fact-checking, the fact-checking extension contacts a remote server such as server 102 of FIG. 1 so that a service such as query service 116 can compare the selected content against a verified information database such as that shown at 120. The query service returns a result to the web browser extension, indicating the result of the comparison. In some embodiments, the query service may be performed in whole or in part on the remote server, or may be performed in whole or in part on multiple servers.

In one example, the result indicates whether a match was found indicating that the selected text is misinformation or fake news, and provides verified information associated with the match for display to the end user if a match indicating the content may be misinformation is found. In a more complex example, the result may further indicate that selected content is verified as true such as by matching the selected content to a verified fact rather than to misinformation in the verified information database. The query service in this example may return an indication that the content is verified as true to the user's web browser fact-checking extension for indication to the user, and in a further example may include verified facts, media, or web links supporting the determination that the selected content is verified as true.

In the case of images, photos, videos, or other non-textual information, the verification process may include a determination of whether the image, photo, or video has been fabricated or altered.

In another example, the displayed content is automatically fact-checked via the browser extension, such as where all the content displayed on the screen in FIG. 2 is automatically fact-checked and relevant results are selectively displayed alongside content. In another example, the page of content may be fact-checked via a user-initiated process, such as by selecting to fact check the page via a left click context menu, via a toolbar icon for the fact-checking browser extension, or the like. In another example, the fact-checking web browser may automatically recognize certain keywords, phrases, or the like that may trigger fact-checking the recognized content and/or the surrounding content, and may automatically display the results of such fact-checking. If the web page contained the words “election,” “vaccine,” “Hillary,” or “Trump,” for example, the surrounding content may be automatically fact-checked via the web browser plugin. In further examples, in addition to the literal words and text, the fact checking may include analysis of the semantics of the text to determine a likelihood of the veracity of the information.

The fact-checking results shown in FIG. 2 are an example of indication to the user of the content being fact-checked and the results of the fact-checking process, irrespective of how the process is initiated. In the top paragraph, a selected phrase indicated in highlighting has been fact-checked, and the resulting fact-checked claims are displayed in the bubble to the right of the web page content, linked by a dotted line. In the second paragraph, the whole paragraph is indicated as selected content for fact checking via a dotted outline, and a fact-checked claim bubble associated with the selected content is again shown to the right. Because the second example comprises a paragraph of text rather than a phrase from a sentence, the fact-checking result bubble shows multiple verified information results, potentially relating to different sentences or phrases within the paragraph. In a further example, an icon such as the checkmark in a star shown in the upper-right corner of the second paragraph's dotted line bubble indicates that the associated content has been fact-checked, which in the absence of fact-check verified information such as that shown in the result bubbles on the right side of the web browser window may be the only indication that the content has been fact-checked.

The examples of FIG. 2 show how a user may select text or other content in a web browser for fact checking, and how fact checking results may be indicated to a user by augmenting the displayed web page content using result bubbles, pop-ups, graphic indicators, or the like. Although certain examples are presented here, other examples exist and are within the scope of the invention, including variations in initiating the web browser extension, selecting content for fact-checking, displaying the results of fact-checking to a user, and the like.

FIG. 3 is a flow diagram of a networked fact-checking system, consistent with an example embodiment. Here, a cloud server 302 comprises a server job 304 and an ingestion job 306, which may perform functions similar to the corresponding elements of server 102 of FIG. 1. A client computer 308 operates browser extension 310, which may send fact-checking requests to the cloud server 302, where the requests are handled by server job 304 using claim check database 312. The result of the request is returned via server job 304 to the client computer's fact-checking browser extension 310, such that results of the fact-checking may be displayed to the user.

Ingestion job 306 populates and/or updates database 312, such as by querying or “scraping” trusted sources of verified data for relevant content. In one such example, trusted news data sources 314, such as CNN.com, APNews.com, NYTimes.com, and the like are searched for content relevant to debunking misinformation or “fake news.” In another example, verified or trusted content sources 316 are searched for content relevant to debunking misinformation, such as the encyclopedic website Wikipedia.com and the fact-checking website Snopes.com. The claim check database 312 may thereby be kept up-to-date with content relative to current misinformation being spread on social media or other websites, helping slow the spread of such misinformation and reduce such misinformation's influence on users.

In a more detailed example, the ingestion job is run periodically such as being processed as a cron job in a Linux environment to regularly search data sources such as trusted news data sources 314 and verified content sources for updated, relevant information. If relevant information that is not already in claim check database 312 is found, the data is processed to fit into the data schema of the claim check database before being stored. The server job may similarly use a variety of different methods to determine the relevance or applicability of data in the claim check database to a request received from a browser extension, such as word or phrase matching, artificial intelligence analysis of content or meaning of phrases or paragraphs, or other such methods. In one such example, the server job searches for the k nearest claims in the claim check database (k=3), computed using cosine similarity of the embeddings produced by a multilingual pre-trained sentence-transformers model. The model in one example may be the paraphrase-multilingual-mpnet-base-v2 from huggingface.co, which maps sentences and paragraphs to a 768 dimensional dense vector space. This model has been experimentally determined to yield good results with an example dataset in comparison with other pre-trained sentence-transformers models available at the time of testing.

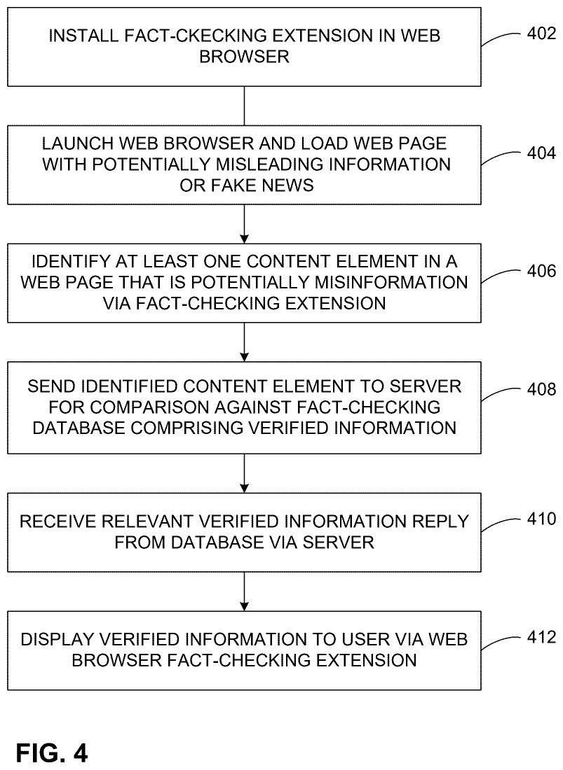

FIG. 4 is a flow diagram of a method of fact-checking web content in a web browser, consistent with an example embodiment. A fact-checking browser extension is installed in a web browser at 402, such as in Chrome, Firefox, Edge, or Safari web browsers. In an alternate embodiment, the web browser may be provided with fact-checking capability preinstalled, such as a modified version of an open-source browser or a browser that has elected to incorporate fact-checking functionality into the primary distribution version of its software.

The web browser is launched at 404, and a web page with potentially misleading information or “fake news” is loaded. In some examples, the fact-checking extension may distinguish between websites prone to having misinformation, such as social media sites like Facebook and Twitter (now X), and websites that are generally trustworthy and aren't likely to have misinformation such as CNN.com and Wikipedia.org. The fact-checking extension may be further configured in some examples to only evaluate certain portions of a website, such as evaluating posts from users but not other content on a social media website.

At 406, the fact-checking extension identified at least one content element in a web page that may potentially be misinformation or fake news, such as a social media post, a graphic or image, or another such web page content element. The content in various examples may be a phrase or sentence, a paragraph, or any other text string that may comprise misleading information. Identified content elements in a further example may be pre-filtered or screened via the web browser for keywords, phrases, or the like that are associated with misinformation, such as COVID, vaccine, election, Trump, Hillary, and the like.

Web page content that may be misinformation or fake news is sent via the fact-checking web browser extension to a server at 408, where a server process compares the received content against a database of known misinformation. This is performed in some examples using keyword or phrase matching, and in other examples will employ artificial intelligence such as a recurrent neural network or pretrained transformer operable to find the closest or most relevant data elements in the database for each element of web content provided in the browser extension's request. In a further example, the database further comprises verified information or facts, such that the web browser extension and server may further indicate whether web page content is verified as true.

The server sends the result of the database query back to the web browser's fact-checking extension at 410, which in various examples may include a verified fact associated with the extension's query, an indication that no relevant content was found in the database, or an indication that the provided content has been determined to be misinformation or verified as true. In further examples, references such as web links or other content may be provided in support of the determination, such that the user may use the references to further educate themselves on the subject matter of the content provided for fact-checking.

At 412, the result of the fact-checking query is displayed to the user via the web browser, such as by displaying a graphic indication that a content element has been fact-checked, displaying a pop-up or text box indicating verified information associated with the query, or providing another indication of fact-checking and/or fact-checking results to the user. Although the example of FIG. 2 shows results in text bubbles to the side of content elements that have been fact-checked, other examples may use highlighting, graphics, sounds, or other such methods to indicate fact-checking results, and may provide a variety of ways for users to interact with the results such as following a link or otherwise providing input to receive more information regarding the selected content.

The examples presented above demonstrate how use of a fact-checking browser extension can verify content on a web page, providing a user with information regarding the veracity of a claim on the web page without having to manually search for a source of trusted information on the subject. This helps prevent the spread of misinformation and better educate users, who are significantly less likely to believe a debunked claim or to spread a debunked claim to others such as via social media. Because a browser extension is relatively easy to install and configure, widespread adoption of fact-checking browser extensions is feasible and may result in improved overall resistance to spreading misinformation, an improved online social media experience, and more harmonious social discourse.

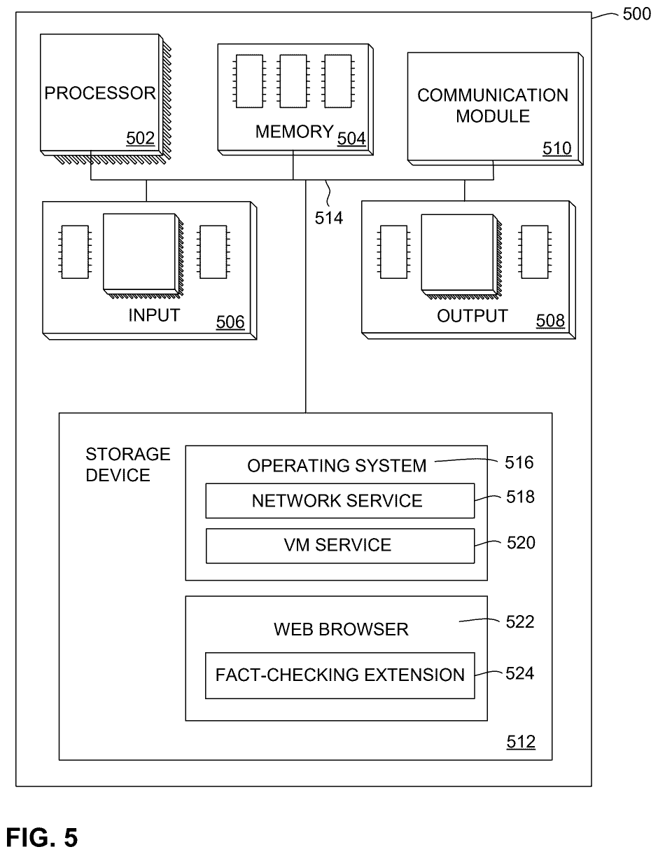

FIG. 5 is a computerized system employing a fact-checking browser extension, consistent with an example embodiment. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500 in one example further includes an operating system 516 executable by computing device 500. The operating system includes in various examples services such as a network service 518 and a virtual machine service 520 such as a virtual server. One or more applications, such as web browser 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as web browser 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as web browser 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 500 uses communication module 510 to communicate with an external device such as via public network 122 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice-responsive system, a video camera, a microphone, or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as web browser 522 to components of computing device 500. For example, operating system 516, in one example, facilitates the communication of various applications such as web browser 522 with processors 502, communication unit 510, storage device 512, input device 506, and output device 508. Applications such as web browser 522 may include program instructions and/or data that are executable by computing device 500. As one example, web browser 522 uses fact-checking extension 524 to identify content in a displayed web page that may comprise misinformation, and to automatically fact-check the information and display a result of the fact-checking to the user. These and other program instructions or modules may include instructions that cause computing device 500 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of fact-checking content in a web browser, comprising:
presenting a web page comprising a plurality of information elements to a user;
identifying at least one content element in the web page that is potentially misinformation;
comparing the at least one content element against a database comprising verified information elements;
determining, while the web page and the plurality of information elements are displayed to the user, whether a verified information element in the database corresponds to the at least one content element; and
if a verified information element in the database is found to correspond to the at least one content element, displaying, on the presented web page, the verified information element in the database in association with the at least one content element via the web browser as additional text, a web link, a pop-up, or a graphic indicating a corresponding fact has been found.

2. The method of fact-checking content in a web browser of claim 1, wherein at least one of: identifying at least one content element, comparing the at least one content element against a database of verified information, determining whether a verified information element in the database corresponds to the at least one content element, and displaying the verified information element, is performed via a browser extension or plugin.

3. The method of fact-checking content in a web browser of claim 1, wherein at least one of: comparing the at least one content element against a database of verified information and determining whether a verified information element in the database corresponds to the at least one content element, is performed in a remote server.

4. The method of fact-checking content in a web browser of claim 1, wherein identifying at least one content element in a web page that is potentially misinformation comprises recognizing at least one of semantics and words in text.

5. The method of fact-checking content in a web browser of claim 4, wherein identifying at least one content element in a web page that is potentially misinformation via recognizing at least one of semantics and words in text comprises evaluation of one or more of sentences and paragraphs in the text.

6. The method of fact-checking content in a web browser of claim 1, wherein identifying at least one content element in a web page that is potentially misinformation comprises recognizing at least one image or photograph that may be fabricated or altered.

7. The method of fact-checking content in a web browser of claim 1, wherein displaying the verified information element in the database in association with the at least one content element via the web browser comprises displaying a verified fact associated with verified information element in the database.

8. (canceled)

9. The method of fact-checking content in a web browser of claim 1, wherein the database of verified information comprises a plurality of external sources of verified information.

10. A computing device, comprising:
a processor and a non-volatile storage, the non-volatile storage comprising instructions that when executed on the computing device cause the computing device to:
execute a web browser and present a web page comprising a plurality of information elements to a user;
identify at least one content element in the web page that is potentially misinformation;
compare the at least one content element against a database comprising verified information elements;
determine, while the web page and the plurality of information elements are displayed, whether a verified information element in the database corresponds to the at least one content element; and
if a verified information element in the database is found to correspond to the at least one content element, display, on the presented web page, the verified information element in the database in association with the at least one content element via the web browser as additional text, a web link, a pop-up, or a graphic indicating a corresponding fact has been found.

11. The computing device of claim 10, wherein at least one of: identifying at least one content element, comparing the at least one content element against a database of verified information, determining whether a verified information element in the database corresponds to the at least one content element, and displaying the verified information element, is performed via a web browser extension or plugin.

12. The computing device of claim 10, wherein at least one of: comparing the at least one content element against a database of verified information and determining whether a verified information element in the database corresponds to the at least one content element, is performed at least in part in a remote server.

13. The computing device of claim 10, wherein identifying at least one content element in a web page that is potentially misinformation comprises recognizing at least one of semantics and words in text.

14. The computing device of claim 13, wherein identifying at least one content element in a web page that is potentially misinformation via recognizing at least one of semantics and words in text comprises evaluation of one or more of sentences and paragraphs in the text.

15. The computing device of claim 10, wherein identifying at least one content element in a web page that is potentially misinformation comprises recognizing at least one image or photograph that may be fabricated or altered.

16. The computing device of claim 10, wherein displaying the verified information element in the database in association with the at least one content element via the web browser comprises displaying a verified fact associated with verified information element in the database.

17. (canceled)

18. The computing device of claim 10, wherein the database of verified information comprises a plurality of external sources of verified information.

19. A method of fact-checking content via a web browser, comprising:
presenting the web page, comprising a plurality of information elements, to a user;
receiving from the web browser at least one content element in a web page that is potentially misinformation;
comparing the at least one content element against a database of verified information;
determining, while the web page and the plurality of information elements are displayed to the user, whether a verified information element in the database corresponds to the at least one content element; and
if a verified information element in the database is found to correspond to the at least one content element, providing the verified information element in the database in association with the at least one content element to the web browser for display to the user while the web page is being displayed, wherein the at least one content element is displayed as additional text, a web link, a pop-up, or a graphic indicating a corresponding fact has been found.

20. The method of fact-checking content via a web browser of claim 19, further comprising updating the database of verified information by automatically scraping one or more external trusted sources of verified information.
